(19) United States
(12) Patent Application Publication
(10) Pub. No.: US 2019/0129976 A1
(43) Pub. Date: May 2, 2019

(54) APPARATUS FOR CONTROLLING SYNCHRONIZATION OF METADATA ON NETWORK AND METHOD FOR THE SAME

(71) Applicant: ELECTRONICS AND TELECOMMUNICATIONS RESEARCH INSTITUTE, Daejeon (KR)

(72) Inventors: Myung-Hoon CHA, Daejeon (KR); Young-Kyun KIM, Daejeon (KR); Hong-Yeon KIM, Daejeon (KR); Sang-Min LEE, Daejeon (KR)

(21) Appl. No.: 16/158,088

(22) Filed: Oct. 11, 2018

(30) Foreign Application Priority Data
Nov. 1, 2017 (KR) 10-2017-0144917

(51) Int. Cl. G06F 17/30

(52) U.S. Cl. CPC G06F 17/30174; G06F 17/30964; G06F 17/30185; G06F 17/30997

(57) ABSTRACT

Disclosed herein is an apparatus for controlling synchronization of metadata, which includes a transaction creation unit for creating a transaction corresponding to a request for an operation for metadata, the request being received from a client; a journal management unit for storing the transaction in a journal; a journal synchronization unit for comparing the journal with an external journal in a node connected with the apparatus and transmitting and receiving only inconsistencies therebetween, thereby synchronizing the journal; and an operation-processing unit for processing the request for the operation or the transaction for the metadata.

### CROSS REFERENCE TO RELATED APPLICATION

This application claims the benefit of Korean Patent Application No. 10-2017-0144917, filed Nov. 1, 2017, which is hereby incorporated by reference in its entirety into this application.

### BACKGROUND OF THE INVENTION

### 1. Technical Field

The present invention relates generally to an apparatus and method for controlling synchronization of metadata on a network, and more particularly to an apparatus and method for controlling a synchronization process in order to efficiently synchronize metadata when the metadata is continuously updated.

### 2. Description of the Related Art

In a distributed file system, a node that manages metadata copies the metadata to an additional node for the availability thereof. Here, the node stores the content of metadata in a table file and uses a journal file in order to perform the process of updating metadata as a transaction. In the distributed file system having the above-described structure, when a file is created, modified or deleted, metadata corresponding thereto must also be created, modified or deleted, and such a metadata operation is processed as a transaction for the consistency and durability of metadata in the file system. When a single metadata operation is performed as a transaction, first, the content of the metadata operation is appended to the journal file, and the table that stores the content of metadata is updated using the journal file. Therefore, it is very important to efficiently copy and synchronize the journal file in order to maintain the availability of metadata in the distributed file system.

However, because the content of the journal file is continuously updated, merely copying the journal file to another computer at regular intervals is not sufficient to provide fault tolerance. If a failure occurs in the computer that stores the original journal file, a computer that stores a copy of the original journal file must immediately start the function of managing metadata. However, if the copy is very inconsistent with the original journal file, when the computer storing the copy starts the function of managing metadata, a large amount of metadata that is recently stored in the computer that stores the original journal file may be lost. Therefore, a method for stably and efficiently synchronizing continuously modified metadata is required.

The above-described information about the related art has been retained by the inventors for the purpose of developing the present invention or was obtained during the process of developing the present invention. Also, it should be appreciated that this information did not necessarily belong to the public domain before the patent filing date of the present invention.

### DOCUMENTS OF RELATED ART

### (Patent Document 1) Korean Patent Application Publication No. 10-2016-0123748.

### SUMMARY OF THE INVENTION

An object of the present invention is to provide an apparatus and method for controlling synchronization of metadata by synchronizing a journal file corresponding to a metadata operation on a network.

Another object of the present invention is to provide an apparatus and method for controlling synchronization of metadata by synchronizing a journal file corresponding to inconsistency between pieces of metadata stored in the devices to be synchronized with each other.

A further object of the present invention is to provide an apparatus and method for controlling synchronization of metadata using a synchronous method in which metadata is synchronized in the state in which a metadata operation is interrupted.

An embodiment of the present invention provides an apparatus for controlling synchronization of metadata, which includes a transaction creation unit for creating a transaction corresponding to a request for an operation for metadata, the request being received from a client; a journal management unit for storing the transaction in a journal; a journal synchronization unit for comparing the journal with an external journal in a node connected with the apparatus and transmitting and receiving only an inconsistency therebetween, thereby synchronizing the journal; and an operation-processing unit for processing the request for the operation or the transaction for the metadata.

Here, the journal management unit may store the transaction in the journal by appending the transaction thereto, and may manage the journal by dividing the journal into units having a preset size.

Here, after the transaction corresponding to the request for the operation is stored in the journal, the operation-processing unit may process the request for the operation or the transaction and reflect a result thereof in a table that stores content of the metadata.

Here, when the journal is changed through the synchronization, the operation-processing unit may process transactions corresponding to the change and reflect a result thereof in the table.

Here, when synchronizing the journal is interrupted because a failure occurs in the node connected with the apparatus, the journal synchronization unit may resynchronize the journal with a new node or with the node in which the failure occurred when the node is normalized.

Here, when the journal synchronization unit resynchronizes the journal, the journal synchronization unit may resynchronize the journal in a time-ordered sequence.

Here, when the journal synchronization unit resynchronizes the journal, the journal synchronization unit may use an asynchronous resynchronization method, in which a function of receiving and processing a new request for an operation for metadata is enabled during resynchronization, or a synchronous resynchronization method, in which the function of receiving and processing a new request for an operation for metadata is disabled during resynchronization.

Here, when the journal synchronization unit resynchronizes the journal, if an amount of inconsistency in the journal is greater than a preset amount, the journal synchronization unit may use the asynchronous resynchronization method, but otherwise, the journal synchronization unit may use the synchronous resynchronization method.

Here, when the journal synchronization unit resynchronizes the journal using the asynchronous resynchronization method, the journal synchronization unit may recalculate the amount of inconsistency in the journal by reflecting a new request for an operation for metadata, which is received during resynchronization of the journal, select the asynchronous resynchronization method or the synchronous resynchronization method in consideration of the recalculated amount of inconsistency, and resynchronize the journal again using the selected method.

Here, when the journal synchronization unit resynchronizes the journal using the synchronous resynchronization method, the journal synchronization unit may start a grace period during which a new request for an operation for metadata is blocked, synchronize the journal when transactions corresponding to requests for operations that were input before the start of the grace period are completed, and finish the grace period when resynchronization of the journal using the synchronous resynchronization method is completed.

Also, an embodiment of the present invention provides a method for controlling synchronization of metadata, which includes creating a transaction corresponding to a request for an operation for metadata, the request being received from a client; storing the transaction in a journal; comparing the journal in a node with an external journal in an additional node connected therewith and transmitting and receiving only an inconsistency between the journal and the external journal, thereby synchronizing the journal; and processing the request for the operation or the transaction for the metadata.

Here, storing the transaction may be configured to store the transaction in the journal by appending the transaction thereto and to manage the journal by dividing the journal into units having a preset size.

Here, processing the request for the operation or the transaction may be configured such that, after the transaction corresponding to the request for the operation is stored in the journal, the request for the operation or the transaction is processed and a result thereof is reflected in a table that stores content of the metadata.

Here, processing the request for the operation or the transaction may be configured such that, when the journal is changed through the synchronization, transactions corresponding to the change are processed and a result thereof is reflected in the table.

Here, synchronizing the journal may include, when synchronizing the journal is interrupted because a failure occurs in the additional node, resynchronizing the journal with a new node or with the additional node when the additional node is normalized.

Here, resynchronizing the journal may be configured to resynchronize the journal in a time-ordered sequence.

Here, resynchronizing the journal may be configured to use an asynchronous resynchronization method, in which a function of receiving and processing a new request for an operation for metadata is enabled during resynchronization, or a synchronous resynchronization method, in which the function of receiving and processing a new request for an operation for metadata is disabled during resynchronization.

Here, resynchronizing the journal may be configured such that, if an amount of inconsistency in the journal is greater than a preset amount, the asynchronous resynchronization method is used, but otherwise, the synchronous resynchronization method is used.

Here, resynchronizing the journal may be configured such that, when the journal is resynchronized using the asynchronous resynchronization method, the amount of inconsistency in the journal is recalculated by reflecting a new request for an operation for metadata, received during resynchronization of the journal, the asynchronous resynchronization method or the synchronous resynchronization method is selected in consideration of the recalculated amount of inconsistency, and the journal is resynchronized using the selected method.

Here, resynchronizing the journal may be configured such that, when the journal is resynchronized using the synchronous resynchronization method, a grace period during which a new request for an operation for metadata is blocked is started, the journal is synchronized when transactions corresponding to requests for operations that were input before the start of the grace period are completed, and the grace period is finished when resynchronization of the journal using the synchronous resynchronization method is completed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a system for controlling synchronization of metadata according to an embodiment of the present invention;

FIG. 2 is a block diagram that shows an example of the apparatus for controlling synchronization of metadata, illustrated in FIG. 1;

FIG. 3 is a view that shows the relationship between an apparatus for controlling synchronization of metadata according to an embodiment of the present invention and neighboring devices;

FIG. 4 is a view that shows data stored in the metadata storage unit illustrated in FIG. 3;

FIG. 5 and FIG. 6 are views that show an example of the process of updating a journal through resynchronization between two nodes according to an embodiment of the present invention;

FIG. 7 is a view that shows an example of the process of resynchronizing a journal illustrated in FIG. 5 and FIG. 6;

FIG. 8 is a flowchart that shows a method for controlling synchronization of metadata according to an embodiment of the present invention;

FIG. 9 is a flowchart that shows an example of the step of synchronizing a journal, illustrated in FIG. 8; and

FIG. 10 is a flowchart that shows an example of the step of performing synchronous resynchronization, illustrated in FIG. 9.

### DESCRIPTION OF THE PREFERRED EMBODIMENTS

Because the present invention may be variously changed and may have various embodiments, specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, and all or some of the embodiments may be selectively combined and configured, and thus the embodiments may be modified in various ways. It will be understood that, although the terms “first”, “second”, etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

The present invention is for a system that copies a file, to which new content is continuously appended, to another computer connected with the system over a network. That is, the present invention is for a system for synchronizing files between nodes or computers connected with each other over a network.

To this end, the present invention performs a metadata operation as a transaction. For example, when a new file is created, creation of an inode for the file and insertion of information about the inode into a parent directory in which the created file is to be included are processed in a single transaction. If these operations are not processed as a transaction, various problems may be caused. For example, when a failure occurs in a metadata management node, an inode for a new file is created, but information about the inode is not inserted into the directory due to the failure, so the new file cannot be retrieved. As described above, in order to prevent a problem in which consistency or durability is not maintained in a file system, a metadata operation is performed as a transaction.

Also, in order to implement a metadata operation, the present invention uses a table for storing the content of metadata and a journal file for storing the content of the metadata operation. For recovery from various kinds of failures that may occur while metadata is being stored, the content of a metadata operation is recorded in the journal file first, and then the content of metadata updated as the result of the metadata operation may be recorded in the table file. That is, a set of the table file and the journal file configures metadata. Because a failure may occur in the node that stores metadata, it is necessary to copy the metadata to another node in order to ensure the availability of the metadata.

Here, the journal file and the table file are continuously changed. Therefore, it is necessary to copy metadata in real time from the node that stores the original metadata to a node that stores a copy of the original metadata. However, if all of the content of the table and the content of the journal file are transmitted to the node for storing the copy, which is connected over a network, a large amount of data must be transmitted. Here, the inefficient process of copying all of the metadata may adversely affect a metadata operation capability, which is the original functionality of the node that stores the original metadata. Also, when a failure occurs in one of the nodes between which metadata is copied, the remaining node must continuously perform metadata operations, which inevitably generates an inconsistency between pieces of metadata stored in the two nodes. When the node in which the failure occurred is normalized and restarted, because the content of the journal and the content of the table stored therein are old, it is necessary to resynchronize the journal and the table using the most recent journal content and the most recent table content. However, a new metadata operation may be input even during resynchronization. Therefore, a resynchronization method that is capable of reducing the burden on the current metadata operation is required. To this end, when metadata is synchronized between nodes, a method of copying only a journal file pertaining to a metadata operation is used, and the specific method will be described below with reference to the accompanying drawings.

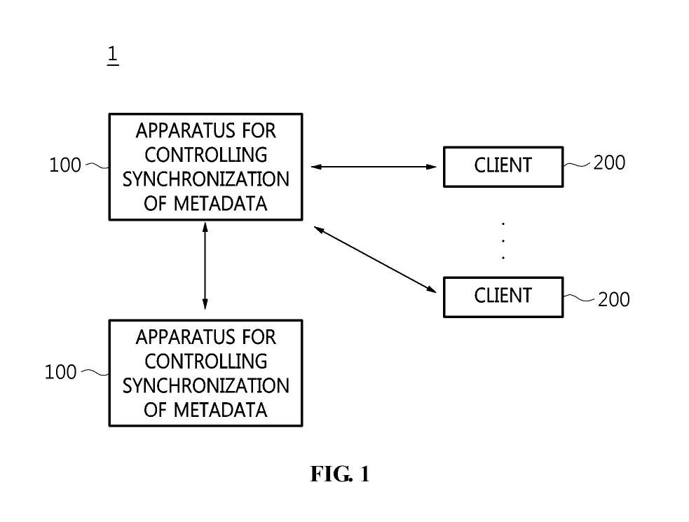

FIG. 1 is a view that shows the configuration of a system 1 for controlling synchronization of metadata according to an embodiment of the present invention.

Referring to FIG. 1, in the system 1 for controlling synchronization of metadata according to an embodiment of the present invention, an apparatus 100 for controlling synchronization of metadata is interconnected with one or more other apparatuses 100 for controlling synchronization of metadata and with a client 200.

When it receives a request for a metadata operation from the client 200, the apparatus 100 for controlling synchronization of metadata according to an embodiment of the present invention creates a transaction corresponding thereto, stores the created transaction in a journal, compares the journal with an external journal in another node, and synchronizes the journal by transmitting and receiving inconsistencies therebetween. Then, the transaction recorded in the journal is performed for the metadata stored in a table, whereby the result of the metadata operation is reflected in the table. When an apparatus 100 for controlling synchronization of metadata receives a journal file from another apparatus 100 for controlling synchronization of metadata, it performs transactions included in the updated part in the journal file and reflects the operation results to the metadata stored in the table. That is, when synchronization is performed, not all of the metadata is copied, but only inconsistencies between journals, which store transactions, is copied, whereby the metadata may be copied at the lowest cost. Also, although metadata is continuously processed, synchronization is performed in units of transactions. Therefore, the synchronization process may be subdivided. Also, even in the event of a failure, the journal may be efficiently resynchronized when the failure is resolved.

Here, the apparatus 100 for controlling synchronization of metadata according to an embodiment of the present invention may include a metadata server for managing metadata, and two or more metadata servers, connected with each other over a network, synchronize metadata therebetween and manage the same. In the present specification, the term ‘node’ may indicate an apparatus 100 for controlling synchronization of metadata.

Here, the apparatus 100 for controlling synchronization of metadata according to an embodiment of the present invention appends a transaction, which is created in response to an operation request, to a journal, thereby storing the same in the journal. Accordingly, transactions for metadata are accumulated in the journal, and a desired metadata-processing result may be acquired by sequentially processing the transactions in the journal. That is, when it receives a request for a metadata operation from the client 200, the apparatus 100 for controlling synchronization of metadata creates a transaction corresponding to the request for the metadata operation, stores the created transaction in a journal by appending the same to the journal, and transmits only the updated part in the journal to another apparatus 100 for controlling synchronization of metadata, thereby synchronizing the journal. Accordingly, the respective apparatuses 100 for controlling synchronization of metadata have the same journal, and may acquire the same metadata by processing the transactions in the same journal.

Here, the apparatus 100 for controlling synchronization of metadata according to an embodiment of the present invention may reflect a transaction, created in response to a request for a metadata operation, in a journal before it processes the transaction and reflects the result in the table. Accordingly, a problem in which a transaction is processed but the transaction is not reflected in the journal due to a failure may be prevented. The present invention intends to maintain the same metadata between apparatuses 100 for controlling synchronization of metadata by synchronizing journals and then making the apparatuses 100 process the same transactions included in the journal. Therefore, transactions may be stored in the journal before the transactions are processed, and the content of metadata is updated based on the result, whereby stability may be improved.

Here, when synchronization of a journal is interrupted because a failure occurs in the node with which synchronization is performed, the apparatus 100 for controlling synchronization of metadata according to an embodiment of the present invention may resynchronize the journal with a new node or with the node in which the failure occurred when the node is normalized. Here, the new node may be a backup node. In the case of a resynchronization process, the amount of inconsistency between journals is relatively large compared to when synchronization is performed normally in units of transactions. This is because requests for metadata operations received while synchronization is interrupted due to the failure are accumulated in the journal when resynchronization with the node that recovers from the failure is attempted. Also, this is because the entire journal must be synchronized when resynchronization with a new node is attempted.

Here, the apparatus 100 for controlling synchronization of metadata according to an embodiment of the present invention selects an asynchronous resynchronization method or a synchronous resynchronization method depending on whether it allows reception of a new request for a metadata operation from the client 200 during resynchronization. The asynchronous resynchronization method allows reception of a new request for a metadata operation during resynchronization. That is, because a new request for a metadata operation is received and processed during resynchronization with another node, when resynchronization is finished, inconsistencies between journals still exists. Conversely, the synchronous resynchronization method blocks reception of a new request for a metadata operation during resynchronization. Because reception of a new request for a metadata operation is blocked during resynchronization with another node, when resynchronization is finished, there is no inconsistency between journals. When the asynchronous resynchronization method is used, because metadata operations are processed while resynchronization is being performed, the availability of metadata in a distributed file system may be realized.

When resynchronization is performed, if the amount of inconsistency between journals is greater than a preset reference amount, the apparatus 100 for controlling synchronization of metadata according to an embodiment of the present invention may use an asynchronous resynchronization method, but otherwise, it may use a synchronous resynchronization method. Also, when resynchronization using the asynchronous resynchronization method is performed, the amount of inconsistency in the journals is calculated again after resynchronization, and a synchronous resynchronization method or an asynchronous resynchronization method may be selected depending on whether the recalculated amount of inconsistency is greater than the preset reference amount. This process is repeated, and when the amount of inconsistency is equal to or less than the preset reference amount, resynchronization using a synchronous resynchronization method is performed, whereby the same journals may be maintained in the two nodes, and the resynchronization process may be completed.

Here, in the case of a synchronous resynchronization method, a grace period may be set in order to block reception of a new request for a metadata operation. For example, when a synchronous resynchronization method is used, a grace period, during which reception of a new request for a metadata operation is blocked, is started. Then, resynchronization is queued until requests for metadata operations that were received before the start of the grace period are completed. Then, the journal in which all of the requests for metadata operations are reflected is set as the target to be resynchronized, and inconsistencies in the journal is transmitted to a resynchronization target node, whereby the journal is copied to the resynchronization target node. Then, the grace period may be finished. Because the synchronous resynchronization method is used when the amount of inconsistency in the journal is small, it takes a short time for resynchronization, and thus few requests may be blocked during resynchronization. When resynchronization using the synchronous resynchronization method is finished, the process of resynchronizing the journal is completed, and after that, the process of synchronizing the journal normally may be performed. Particularly, new requests for metadata operations that were input during the grace period are not reflected in the journal, but are temporarily stored in a buffer, whereby the input requests for metadata operations may be performed after the grace period is finished.

The client 200 is a terminal device that is connected with the apparatus 100 for controlling synchronization of metadata, and may be a device that is capable of requesting a metadata operation and using metadata by accessing the metadata that is managed by the apparatus 100 for controlling synchronization of metadata. The client 200 may be a general-purpose computer or a dedicated terminal for using metadata or for requesting processing of metadata. Multiple clients 200 may be connected with a single apparatus 100 for controlling synchronization of metadata.

Accordingly, when a certain node provides a specific service outside based on the content of a file stored therein in an environment in which nodes are connected with each other over a network, even though a failure occurs in the certain node, the certain node may be switched with another redundant node, whereby an environment in which the original service is provided without interruption may be constructed.

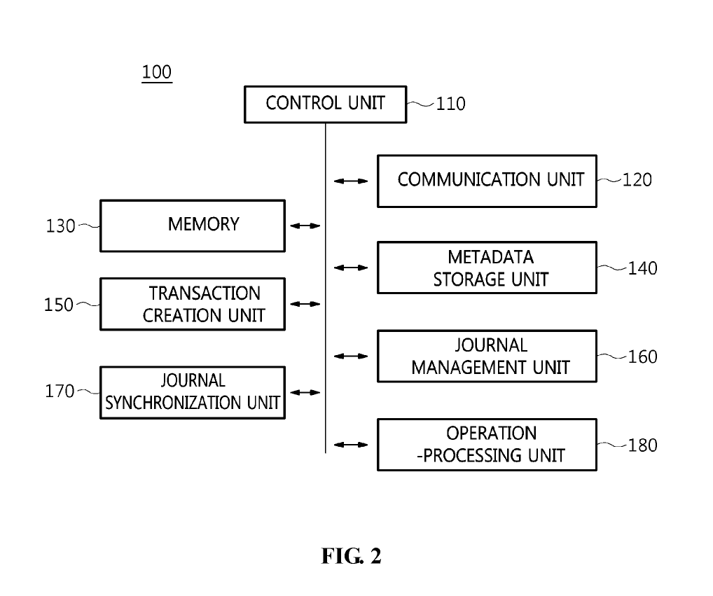

FIG. 2 is a block diagram that shows an example of the apparatus 100 for controlling synchronization of metadata illustrated in FIG. 1.

Referring to FIG. 2, the apparatus 100 for controlling synchronization of metadata according to an embodiment of the present invention includes a control unit 110, a communication unit 120, memory 130, a metadata storage unit 140, a transaction creation unit 150, a journal management unit 160, a journal synchronization unit 170, an operation-processing unit 170, and the like.

Specifically, the control unit 110 is a kind of central processing unit, and controls the overall process of controlling synchronization of metadata. That is, the control unit 110 may provide various functions by controlling the transaction creation unit 150, the journal management unit 160, the journal synchronization unit 170, the operation-processing unit 180, and the like.

Here, the control unit 110 may include all kinds of devices capable of processing data, such as a processor or the like. Here, the term ‘processor’ may indicate, for example, a data-processing device embedded in hardware, which has a circuit physically structured for performing functions represented as code or instructions included in a program. Examples of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 120 provides a communication interface that is necessary when the apparatus 100 for controlling synchronization of metadata sends and receives signals to and from another apparatus 100 for controlling synchronization of metadata or a client (200 in FIG. 1).

Here, the communication unit 120 may be a device including hardware and software that are necessary in order to send and receive signals, such as control signals or data signals, to and from another network device through wired or wireless connection therewith.

The memory 130 functions to temporarily or permanently store data processed by the control unit 110. Here, the memory 130 may include magnetic storage media or flash storage media, but the present invention is not limited thereto.

Here, the memory 130 may include a buffer that temporarily stores a request for a metadata operation.

The metadata storage unit 140 stores metadata to be managed. That is, the metadata storage unit 140 functions to store metadata that is created or modified as a result of a metadata operation.

Here, the metadata storage unit 140 may store metadata such that a journal for storing transactions corresponding to metadata operations is separate from a table for storing the content of metadata.

The transaction creation unit 150 creates transactions corresponding to requests for metadata operations that are input from one or more clients (200 in FIG. 1). Here, for each request for a metadata operation, a single transaction is created.

The journal management unit 160 manages a journal for storing transactions pertaining to metadata and stores the transaction created by the transaction creation unit 150 in the journal.

Here, the journal management unit 160 may store a transaction in the journal by appending the same to the journal. That is, when a new transaction is created, the transaction is appended to the journal, whereby all of the transactions may be retrieved from the journal.

Here, the journal management unit 160 may manage the journal by dividing the same into units having a preset size. Also, the respective journal files may be managed in the order in which they are written. For example, when the size of a single journal file is set to 10 kB, transactions may be appended to a journal file such that the size of the journal file does not exceed 10 kB.

The journal synchronization unit 170 synchronizes a journal to another node by copying the journal thereto. Specifically, the journal pertaining to the metadata is synchronized from the node storing the original metadata to a synchronization target node.

Here, in order to synchronize a journal with another node at the lowest cost, the journal synchronization unit 170 may determine inconsistencies between the journal and a journal in the other node and transmit or receive only the inconsistencies, whereby the journal may be copied. For example, when the journal in node A contains transaction 1, transaction 2, and transaction 3 and when the journal in node B contains transaction 1 and transaction 2, the node A transmits the transaction 3 to the node B, whereby the journal may be synchronized. Here, when a journal in a certain node contains more transactions than a journal in a counterpart node, the certain node transmits the content corresponding to the inconsistency to the counterpart node, but when the journal in the counterpart node contains more transactions, the certain node may receive the content corresponding to the inconsistency therefrom.

Here, when synchronization of the journal is interrupted because a failure occurs in a node with which synchronization is performed, the journal synchronization unit 170 may resynchronize the journal with a new node or the node in which the failure occurred when the node is normalized. The journal may be synchronized between multiple nodes, but when a failure occurs in a certain node, synchronization with the node is interrupted.

That is, depending on the selection, the journal may be resynchronized to a new node with which synchronization has not been performed, or the journal may be resynchronized to the node in which the failure occurred when the node recovers from the failure. The process of resynchronizing the journal to a new node may be regarded as a process for constructing a backup node in order to reduce the risk of metadata loss.

Here, when failures occur in all synchronization target nodes, other than the node that stores the original metadata, the journal synchronization unit 170 may resynchronize the journal to a new node in order to safely store the metadata. When the journal is resynchronized to a new node, the node in which the failure occurred may be excluded from the synchronization target nodes, or the journal may be resynchronized to the node when the node recovers from the failure.

Here, the journal synchronization unit 170 may resynchronize the journal in a time-ordered sequence. Because transactions are stored in the journal in the order in which the transactions are created and because the journal is divided into journal files having a fixed size, the journal files are resynchronized in the order from the oldest one to the newest one, whereby the sequence of the requests for metadata operations may be maintained.

Here, when it resynchronizes the journal, the journal synchronization unit 170 may use an asynchronous resynchronization method, in which the function of receiving and processing a request for a metadata operation is enabled during resynchronization, or a synchronous resynchronization method, in which the function of receiving and processing a request for a metadata operation is disabled during resynchronization. The asynchronous resynchronization method allows reception of a new request for a metadata operation during resynchronization. That is, because a new request for a metadata operation is received and processed during resynchronization with another node, when resynchronization is finished, inconsistencies between journals still exists. Conversely, the synchronous resynchronization method blocks reception of a new request for a metadata operation during resynchronization. Because reception of a new request for a metadata operation is blocked during resynchronization with another node, when resynchronization is finished, there is no inconsistency between journals. When the asynchronous resynchronization method is used, because metadata operations are processed while resynchronization is being performed, the availability of metadata in a distributed file system may be provided.

Here, the journal synchronization unit 170 may perform resynchronization as many times as the preset number of times, in which case the final resynchronization process is performed using the synchronous resynchronization method and the remaining resynchronization processes are performed using the asynchronous resynchronization method. For example, if a resynchronization procedure is set so as to perform a resynchronization process N times, the journal is resynchronized using the asynchronous resynchronization method until the (N−1)-th resynchronization process, and the final N-th resynchronization process may be performed using the synchronous resynchronization method. That is, because the final process of the resynchronization procedure is performed using the synchronous resynchronization method, the same journals may be maintained, whereby the resynchronization procedure may be completed, and the step of normal synchronization may be resumed.

Here, when resynchronization is performed, if the amount of inconsistency between journals is greater than a preset reference amount, the journal synchronization unit 170 may use an asynchronous resynchronization method, but otherwise, it may use a synchronous resynchronization method. Also, when resynchronization using the asynchronous resynchronization method is performed, the amount of inconsistency between the journals is calculated again after resynchronization, and a synchronous resynchronization method or an asynchronous resynchronization method may be selected depending on whether the recalculated amount of inconsistency is greater than the preset reference amount. This process is repeated, and when the amount of inconsistency is equal to or less than the preset reference amount, resynchronization using a synchronous resynchronization method is performed, whereby the same journals may be maintained in the two nodes, and the resynchronization procedure may be completed.

For example, assume that a resynchronization procedure is set such that a synchronous resynchronization method is used only when the amount of inconsistency between journals is equal to or less than 1 kB. Here, when the amount of inconsistency between journals in the nodes to be resynchronized with each other is 10 kB, the first resynchronization of the journal is performed using the asynchronous resynchronization method. When the first resynchronization is finished, the amount of inconsistency between the journals is recalculated in consideration of new requests for metadata operations that were input during the first resynchronization. If the recalculated amount of inconsistency between the journals is 3 kB, the second resynchronization is performed using the asynchronous resynchronization method. When the second resynchronization is finished, the amount of inconsistency between the journals is recalculated in consideration of new requests for metadata operations that were input during the second resynchronization. If the recalculated amount of inconsistency between the journals is 1 kB, the third or the final resynchronization of the journal is performed using a synchronous resynchronization method. Because the third resynchronization is performed using the synchronous resynchronization method, the journal is resynchronized in the state in which reception of a new request for a metadata operation is blocked, whereby the two nodes may maintain the same journals.

Here, when it uses a synchronous resynchronization method, the journal synchronization unit 170 may set a grace period in order to block reception of a new request for a metadata operation. For example, when a synchronous resynchronization method is used, a grace period, during which reception of a new request for a metadata operation is blocked, is started. Then, resynchronization is queued until the requests for metadata operations that were received before the start of the grace period are reflected in the journal. Then, the journal in which all of the requests for metadata operations are reflected is set as the target to be resynchronized, and inconsistencies in the journal is transmitted to a resynchronization target node, whereby the journal is copied to the resynchronization target node. Then, the grace period may be terminated. Because the synchronous resynchronization method is used only when the amount of inconsistency in the journal is small, it takes a short time for resynchronization, and thus few requests may be blocked during resynchronization. After resynchronization using the synchronous resynchronization method is performed, the process of resynchronizing the journal is completed, and a process for synchronizing a journal normally may be performed. Particularly, the new requests for metadata operations that were input during the grace period are not reflected in the journal, but are temporarily stored in a buffer, whereby the input requests for metadata operations may be processed after the grace period is finished.

The operation-processing unit 180 processes a received request for a metadata operation or a transaction and reflects the processing result in the table. That is, the operation-processing unit 180 performs an operation on the metadata stored in the metadata storage unit 140, thereby performing the process of retrieving, creating, modifying, or deleting the metadata.

Here, the operation-processing unit 180 may perform an operation immediately upon receiving a request for the metadata operation, but may perform an operation on metadata using a transaction created in response to a request for the metadata operation.

Here, the operation-processing unit 180 may perform transactions stored in the journal in the order in which they are stored, and may reflect the result of the operation on the metadata in the table. That is, the operation-processing unit 180 may function to reconstruct metadata by replaying the transactions stored in the journal.

Here, when an operation request is input, a transaction for the operation request is created and stored in the journal before the operation-processing unit 180 processes the operation request or the transaction and reflects the processing result in the table. If an operation is performed before a transaction corresponding thereto is stored in the journal, when an error occurs while the transaction is being stored in the journal, the journal may not store the transaction corresponding to the operation although the result of the operation is already reflected to metadata. Accordingly, synchronization of the metadata using the journal may not be performed. That is, because an operation for the metadata may be performed using a transaction stored in the journal, the process of storing the transaction in the journal may be performed before the process of performing the operation.

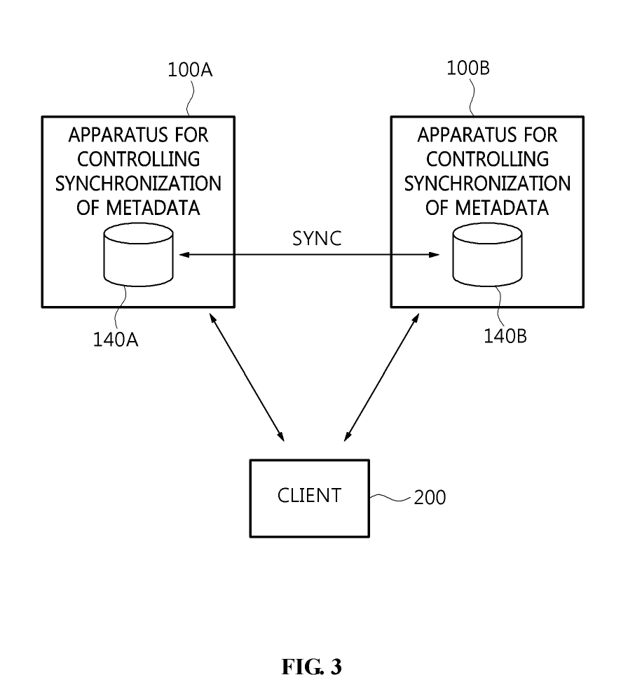

FIG. 3 is a view that shows the relationship between an apparatus for controlling synchronization of metadata according to an embodiment of the present invention and neighboring devices.

Referring to FIG. 3, apparatuses 100a and 100b for controlling synchronization of metadata according to an embodiment of the present invention are connected with each other over a network. The apparatus 100a for controlling synchronization of metadata stores a journal and a table corresponding to metadata in the metadata storage unit 140a thereof, and the apparatus 100b for controlling synchronization of metadata stores a journal and a table corresponding to metadata in the metadata storage unit 140b thereof. Then, the two apparatuses 100a and 100b for controlling synchronization of metadata synchronize the journals with each other, whereby the pieces of metadata stored in the metadata storage units 140a and 140b are synchronized.

The client 200 may be provided with a service related to metadata by being connected with the two apparatuses 100a and 100b for controlling synchronization of metadata. This is because the apparatuses 100a and 100b for controlling synchronization of metadata function as metadata servers. When a failure occurs in the apparatus 100a for controlling synchronization of metadata while the client 200 is being provided with a service therefrom, the client 200 may be continuously provided with the service from the apparatus 100b for controlling synchronization of metadata. This is possible because the two apparatuses 100a and 100b for controlling synchronization of metadata maintain the same metadata by synchronizing the same.

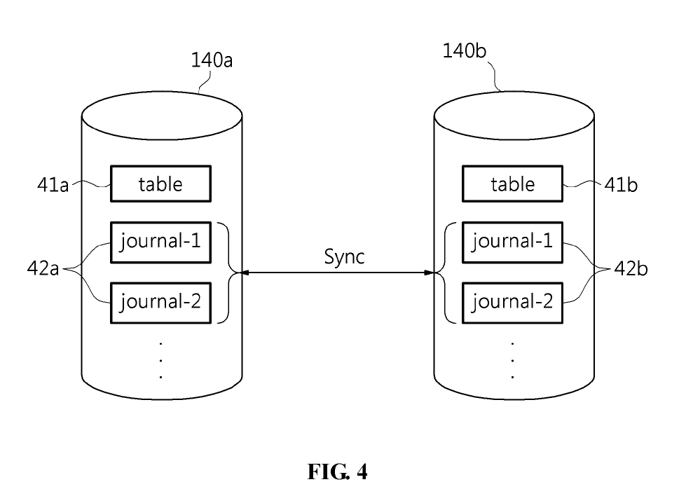

FIG. 4 is a view that shows data stored in the metadata storage units 140a and 140b illustrated in FIG. 3.

Referring to FIG. 4, the metadata storage units 140a and 140b illustrated in FIG. 3 store tables 41a and 41b, which store the content of metadata, and journals 42a and 42b, which store transactions corresponding to requests for metadata operations.

As described above, when a request for an operation for metadata is input, a transaction is created and stored in the journal, the operation for metadata is processed, and the result of the operation is reflected in the table.

Here, the journal 42a or 42b may store transactions by appending the same thereto, and may be divided into units having a preset size. For example, each journal file may have a size that is equal to or less than 10 kB.

Here, the journals 42a and 42b, which store transaction information related to metadata, are copied onto each other, whereby the metadata may be synchronized at a lower cost than when all of the metadata is copied. Particularly, because only the content that is newly appended to the journal or only an inconsistency between the journals is transmitted and received for synchronization, the synchronization costs may be reduced. After the journal is synchronized from another node, transactions newly appended to the journal are processed, and the result is reflected in the table, whereby the same metadata may be maintained in the two nodes.

Here, synchronization may be performed in units of journal files. For example, when journal 1 is created in node A, the journal 1 is synchronized to node B. When journal 2 is created in the node A due to the creation of a new transaction, the journal 2 may be synchronized to the node B.

Accordingly, because only information about a metadata operation is transmitted to another metadata server, the data transfer amount required for synchronization of metadata may be significantly reduced. Also, transmission of additional information, such as a bitmap for indicating a changed disk block, or the like, which is required by a general replication program, is not necessary. Accordingly, inefficiency caused when the entire disk block must be transmitted even though the disk block includes only a small change may be prevented.

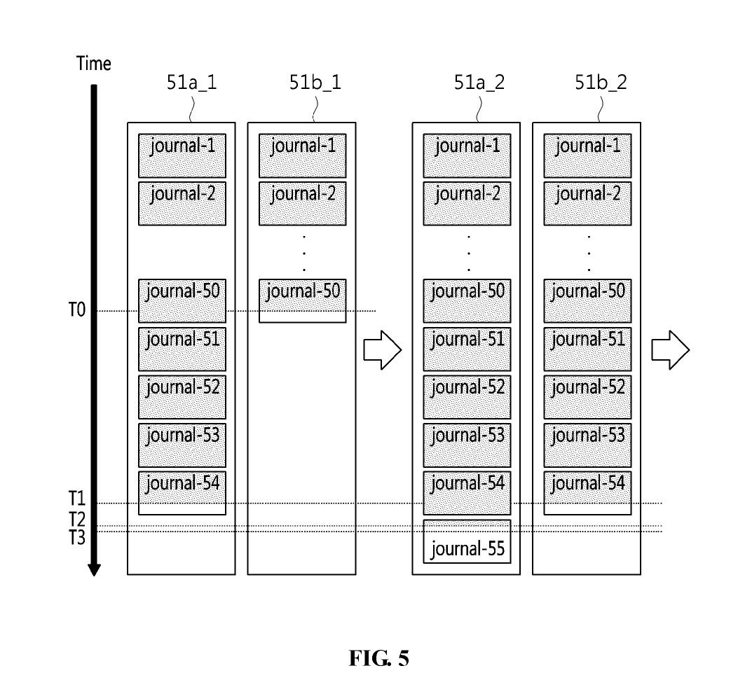

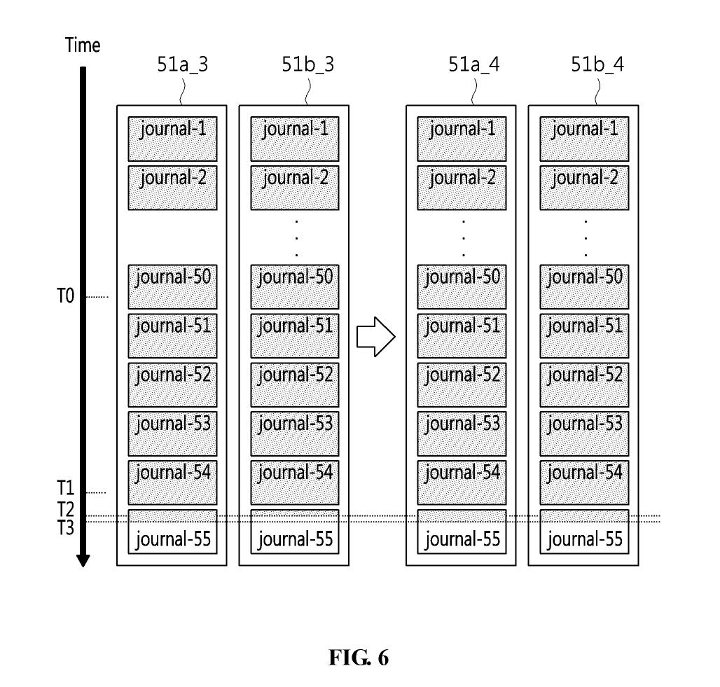

FIGS. 5 and 6 are views that show an example in which journals are changed through resynchronization between two nodes according to an embodiment of the present invention.

In FIGS. 5 and 6, each journal file is represented as a block, and the shaded part in each block represents the amount of data stored in the corresponding journal file. Because a transaction is stored in the journal by being appended thereto, the shaded part in the journal block becomes larger over time, and when the last journal block is filled up with the shaded part, a new journal block is created. Because a table is not a target to be copied, only journals are illustrated in the drawing. On the time axis, a time value increases from top to bottom.

Referring to FIGS. 5 and 6, a failure occurs in one of the two nodes at the time point T0, and the failure is resolved at T1. Assuming that a source node in which no failure occurs is node a, and that the node in which the failure occurred is node b, the journal 51a_1 indicates the journal in the node a at T1, and the journal 51b_1 indicates the journal in the node b at T1. Because the node b is not synchronized with the node a during the period from T0 to T1 due to the failure, the journal 51a_1 in the node a is very inconsistent with the journal 51b_1 in the node b at T1. Because the journal in the node b has content synchronized at T0, resynchronization between the node a and the node b is started at T1, which is the time at which the failure is resolved.

When resynchronization is started at T1, the target to be resynchronized is journal data accumulated in the node a during the period from T0 to T1. The process of resynchronizing the journal data accumulated during the period from T0 to T1 is terminated at T2. The journal 51a_2 indicates the journal in the node a at T2, and the journal 51b_2 indicates the journal in the node b at T2. That is, through the first resynchronization, the journal in the node b becomes the same as the journal that was in the node a at T1. However, because the node a received a new request for an operation for metadata during the first resynchronization (from T1 to T2), the size of the journal in the node a is increased. Therefore, the second resynchronization between the node a and the node b is started at T2.

When the second resynchronization is started at T2, the target to be resynchronized is journal data accumulated in the node a during the period from T1 to T2. The process of resynchronizing the journal data accumulated during the period from T1 to T2 is terminated at T3. The journal 51a_3 indicates the journal in the node a at T3, and the journal 51b_3 indicates the journal in the node b at T3. That is, through the second resynchronization, the journal in the node b becomes the same as the journal that was in the node a at T2. Similarly, because the node a received a new request for an operation for metadata during the second resynchronization (from T2 to T3), the size of the journal in the node a is increased. However, thanks to the repeatedly performed resynchronization, the size of the portion of the target to be resynchronized is reduced so as to be equal to or less than a preset reference amount. Therefore, using a synchronous resynchronization method, the third resynchronization between the node a and the node b is started at T3.

When the third resynchronization is started at T3, the target to be resynchronized is journal data accumulated in the node a during the period from T2 to T3. The journal 51a_4 indicates the journal in the node a when the third resynchronization is terminated, and the journal 51b_4 indicates the journal in the node b when the third resynchronization is terminated. That is, when the third resynchronization is terminated, the journal in the node b becomes the same as the journal in the node a. This is because the third resynchronization is performed using a synchronous resynchronization method, that is, a grace period is set and the node a blocks reception of a new request for an operation for metadata during the grace period. When such synchronous resynchronization is finished, a new request for an operation for metadata may be received again by terminating the grace period, and normal synchronization of the journal may be resumed. Accordingly, through the synchronous resynchronization, the same journal may be copied between the two nodes, whereby the resynchronization process may be completed.

The gist of the description with reference to FIGS. 5 and 6 is that the process of resynchronizing metadata may be classified into an asynchronous resynchronization method, in which reception of a new request for a metadata operation is allowed without setting a grace period, and a synchronous resynchronization method, in which reception of a new request for a metadata operation is blocked by setting a grace period. Also, asynchronous resynchronization may be repeatedly performed multiple times, and synchronous resynchronization may be performed for a short time, whereby new requests for operations for metadata blocked during resynchronization of metadata may be significantly reduced.

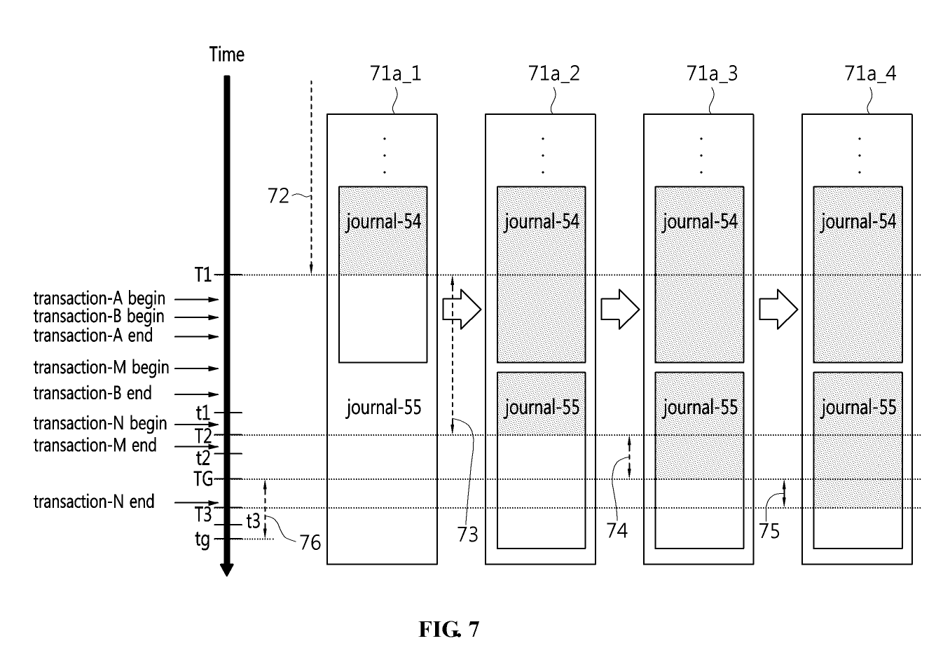

FIG. 7 is a view that shows an example of the process of resynchronizing a journal, illustrated in FIG. 5 and FIG. 6.

FIG. 7 more specifically illustrates the metadata resynchronization process in FIG. 5 and FIG. 6. In FIG. 7, each journal file is represented as a block, and the shaded part in each block represents the amount of data stored in the corresponding journal file. Because a transaction is stored in the journal by being appended thereto, the shaded part in the journal block becomes larger over time, and a new journal block is created when the last journal block is filled up with the shaded part. On the time axis, a time value increases from top to bottom. Particularly, FIG. 7 illustrates only original journal files to be copied, which are stored in the node a (the node a in FIG. 5), in which no failure occurred.

Referring to FIG. 7, T1 is the time at which the first resynchronization is started, and t1 is the time at which the first resynchronization is finished. T2 is the time at which the second resynchronization is started, and t2 is the time at which the second resynchronization is finished. T3 is the time at which the third resynchronization is started, and t3 is the time at which the third resynchronization is finished. TG is the start time of a grace period, and tg is the end time of the grace period. Here, TG may be the time at which the grace period starts and preparation for the third resynchronization is started. Also, 71a_1 is the journal in the node a at T1, 71a_2 is the journal in the node a at T2, 71a_3 is the journal in the node a at TG, and 71a_4 is the journal in the node a at T3.

When the time reaches T1 because a long time has passed since a failure occurred in one node (node b), among metadata servers between which metadata is copied, it may be confirmed that copying of metadata is interrupted for a substantial period, and that new requests for metadata operations are continuously input to the normal metadata server (node a) during the period. When the metadata server in which the failure occurred (node b) is restarted and made ready for a resynchronization process by recovering from the failure, inconsistencies 72 in the journal, which are accumulated until T1, are set as the target to be resynchronized, and the inconsistencies 72 are asynchronously resynchronized to the restarted metadata server (node b). Because new requests for metadata operations are continuously input during asynchronous resynchronization, the journal file, which is the source of synchronization, is continuously changed.

For example, while the first resynchronization is being performed, that is, during the period from T1 to t1, events, such as the start of transaction-A, the start of transaction-B, the end of transaction-A, the start of transaction-M, and the end of transaction-B, may occur in the order in which they are listed. Accordingly, although the process of resynchronizing the inconsistencies, which are accumulated until T1, to the restarted metadata server is finished at t1, inconsistency is newly caused due to the part added during the period from T1 to T2. For example, during the period from t1 to T2, that is, the period from the time at which the first resynchronization is finished to the time at which the second resynchronization is started, an event such as the start of transaction-N may occur.

If metadata resynchronization has not completed and if inconsistencies in the journal still exists, asynchronously resynchronizing inconsistencies in metadata, which is the part 73 changed during the period from T1 to T2, is started again. Similarly, because the asynchronous resynchronization process is performed, reception of a new request for an operation is allowed during the resynchronization process. Accordingly, when the second resynchronization is finished at t2, inconsistencies may still exist in the journal.

Because metadata resynchronization has not completed and inconsistencies still exist in the journal, it is necessary to start a resynchronization process again. In order to perform the third resynchronization, the amount of inconsistency in the journal is recalculated at TG. However, because the amount of inconsistency 74 to be resynchronized is not greater than a preset reference amount, the final resynchronization may be performed using a synchronous resynchronization method. In this case, as the preparation for the synchronous resynchronization, a grace period is started at TG, and reception of new requests for operations may be blocked during the grace period. Here, the synchronous resynchronization process is queued until the transactions that were input before TG, which is the start time of the grace period, but are not yet processed are completed. After the transactions are completed, inconsistencies (74 and 75) are set as the target to be resynchronized at T3, and the third resynchronization is started. When the third resynchronization is finished at t3, the grace period is finished at tg. That is, synchronous resynchronization may be started in the state in which new inconsistency does not occur. For example, when a transaction-N end event occurs after the grace period is started at TG, and when the third resynchronization is started at T3, the transaction-N 76 that ends during the grace period may be included in the target of the third resynchronization, and then the third resynchronization may be performed.

After synchronous resynchronization is finished at t3, because the metadata journals in the two nodes are synchronized, the pieces of metadata stored in the two nodes are the same as each other. Accordingly, after t3, metadata synchronization is performed in the normal state. That is, the process in which the content of a metadata operation newly appended to the most recent journal file is copied to a counterpart metadata server in real time is continuously performed.

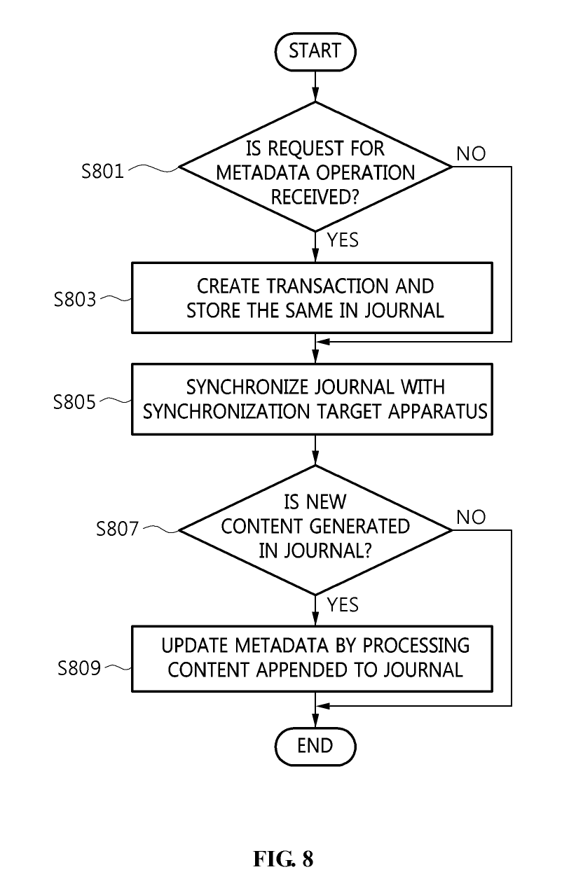

FIG. 8 is a flowchart that shows a method for controlling synchronization of metadata according to an embodiment of the present invention.

Referring to FIG. 8, in the method for controlling synchronization of metadata according to an embodiment of the present invention, whether an apparatus (100 in FIG. 1) for controlling synchronization of metadata receives a request for a metadata operation from a client is determined at step S801.

When it is determined at step S801 that a request for a metadata operation is received, a transaction corresponding thereto is created and stored in a journal at step S803.

When it is determined at step S801 that no request is received, or when the step S803 is performed, the journal is synchronized with a synchronization target apparatus at step S805.

Here, the journal may be synchronized by transmitting and receiving only inconsistencies in the journal to and from the synchronization target apparatus.

Also, in the method for controlling synchronization of metadata according to an embodiment of the present invention, the apparatus (100 in FIG. 1) for controlling synchronization of metadata determines at step S807 whether new content is generated in the journal through synchronization of the journal or through reception of a new request for an operation.

When it is determined at step S807 that new content is generated in the journal, transactions corresponding to the content appended to the journal are processed, whereby metadata is updated and the result is reflected in the table at step S809.

The steps illustrated in FIG. 8 are repeated, whereby metadata may be synchronized between multiple nodes.

Accordingly, a request for a metadata operation is received, a transaction corresponding thereto is stored in a journal, and the journal is synchronized, whereby metadata may be synchronized at low cost.

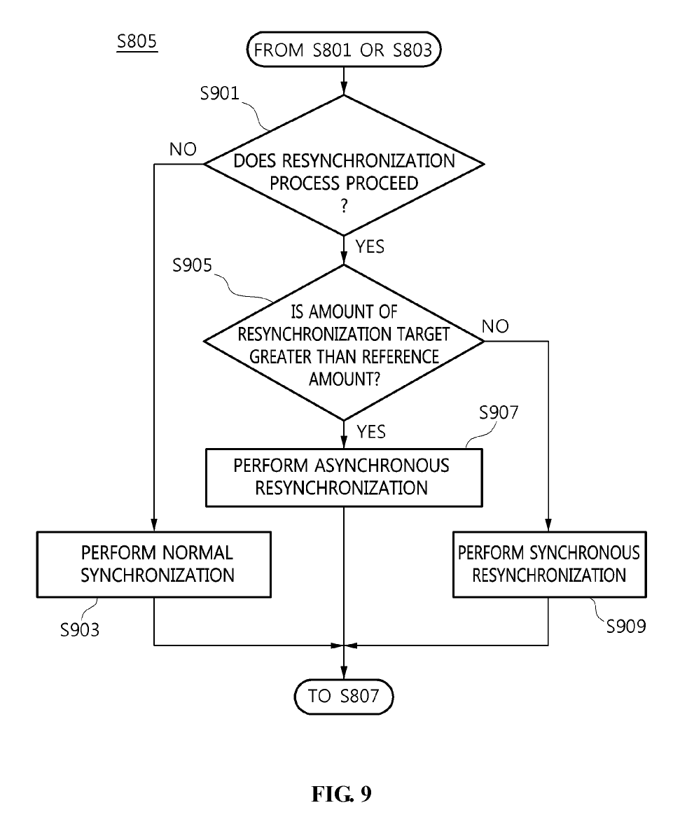

FIG. 9 is a flowchart that shows an example of the step (S805) of synchronizing a journal illustrated in FIG. 8.

Referring to FIG. 9, in the step (S805) of synchronizing a journal, illustrated in FIG. 8, whether to perform a resynchronization process for the journal is determined at step S901. When it is necessary to continue a resynchronization process because the resynchronization process is already started or when it is necessary to start a resynchronization process because a failure occurred in a synchronization target apparatus, the resynchronization process is determined to be performed. Conversely, when a resynchronization process does not proceed and when no failure occurs in the synchronization target apparatus, it may be determined that a resynchronization process is not to be performed.

When it is determined at step S901 that a resynchronization process is not to be performed, the journal is synchronized normally at step S903. Here, in contrast to resynchronization, normal synchronization means that the journal is synchronized whenever a request for an operation for metadata is input because no failure occurs in the nodes.

When it is determined at step S901 that a resynchronization process is to be performed, whether the amount of data to be resynchronized is greater than a preset reference amount is determined at step S905. Here, the amount of data to be resynchronized may correspond to the amount of inconsistency between an original journal and the journal to be resynchronized therefrom.

When it is determined at step S905 that the amount of data to be resynchronized is greater than the preset reference amount, the resynchronization process may be performed using an asynchronous resynchronization method.

When it is determined at step S905 that the amount of data to be resynchronized is not greater than the preset reference amount, the resynchronization process may be performed using a synchronous resynchronization method. Particularly, when the resynchronization process is performed using the synchronous resynchronization method, the corresponding resynchronization process is the last resynchronization process, whereby resynchronization may be completed.

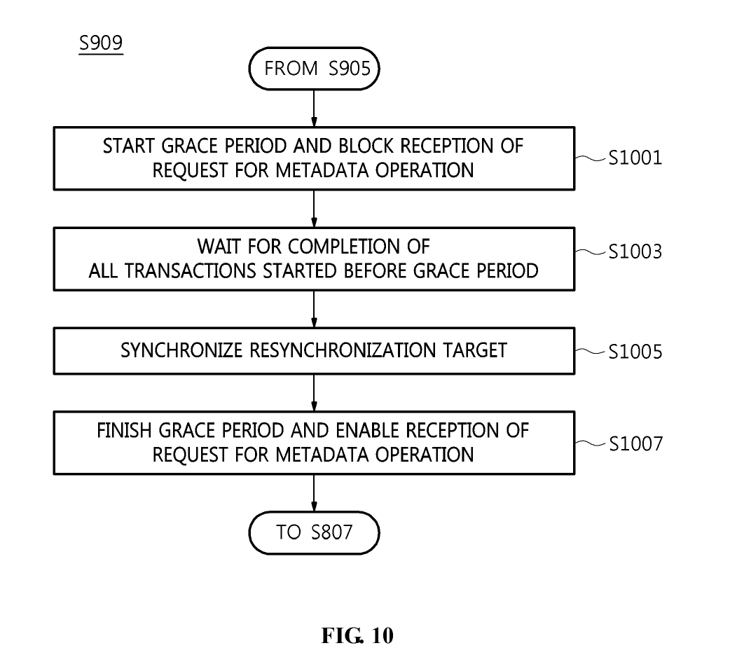

FIG. 10 is a flowchart that shows an example of the step (S909) of performing synchronous resynchronization, illustrated in FIG. 9.

Referring to FIG. 10, in the step (S909) of performing synchronous resynchronization, illustrated in FIG. 9, a grace period is started, and reception of a request for a metadata operation is blocked at step S1001.

Also, in the step (S909) of performing synchronous resynchronization, illustrated in FIG. 9, synchronous resynchronization is queued at step S1003 until all of the transactions that were started before the grace period at step S1001 are completed.

Also, in the step (S909) of performing synchronous resynchronization, illustrated in FIG. 9, a target to be resynchronized is set, and the target is synchronized at step S1005.

Also, in the step (S909) of performing synchronous resynchronization, illustrated in FIG. 9, when synchronization at step S1005 is finished, the grace period is finished, and reception of a request for a metadata operation is enabled at step S1007.

That is, when a synchronous resynchronization method is used, reception of a new request for an operation is blocked during the grace period, whereby the same journals may be maintained after resynchronization is performed.

The above-described embodiment of the present invention may be implemented as program instructions executable by various computer components, and may be recorded in computer-readable storage media. The computer-readable storage media may separately or collectively include program instructions, data files, data structures, and the like. The program instructions recorded in the computer-readable storage media may be specially designed and configured for the embodiment, or may be available due to being well known to computer software experts. Examples of the computer-readable storage media include magnetic media such as a hard disk, a floppy disk and a magnetic tape, optical media such as a CD-ROM and a DVD, magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations according to the present invention and vice-versa.

According to the present invention, through the apparatus and method for controlling synchronization of metadata, a journal file corresponding to a metadata operation is synchronized on a network, whereby metadata may be synchronized using a smaller amount of resources than when synchronization is performed by transmitting the metadata itself.

Also, according to the present invention, through the apparatus and method for controlling synchronization of metadata, a journal file, corresponding to inconsistency between pieces of metadata stored in the devices to be synchronized with each other, is synchronized, whereby metadata may be efficiently synchronized.

Also, according to the present invention, through the apparatus and method for controlling synchronization of metadata, a synchronous method in which metadata is synchronized in the state in which a metadata operation is interrupted is used, whereby the problem of inconsistency in metadata, which is caused due to a metadata operation generated during synchronization, may be prevented.

Although specific embodiments have been described in the specification, they are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. An apparatus for controlling synchronization of metadata, comprising:
a transaction creation unit for creating a transaction corresponding to a request for an operation for metadata, the request being received from a client;
a journal management unit for storing the transaction in a journal;
a journal synchronization unit for comparing the journal with an external journal in a node connected with the apparatus and transmitting and receiving only an inconsistency therebetween, thereby synchronizing the journal; and
an operation-processing unit for processing the request for the operation or the transaction for the metadata.

2. The apparatus of claim 1, wherein the journal management unit stores the transaction in the journal by appending the transaction thereto and manages the journal by dividing the journal into units having a preset size.

3. The apparatus of claim 2, wherein, after the transaction corresponding to the request for the operation is stored in the journal, the operation-processing unit processes the request for the operation or the transaction and reflects a result thereof in a table that stores content of the metadata.

4. The apparatus of claim 3, wherein, when the journal is changed through the synchronization, the operation-processing unit processes transactions corresponding to the change and reflects a result thereof in the table.

5. The apparatus of claim 4, wherein, when synchronizing the journal is interrupted because a failure occurs in the node connected with the apparatus, the journal synchronization unit resynchronizes the journal with a new node or with the node in which the failure occurred when the node is normalized.

6. The apparatus of claim 5, wherein, when the journal synchronization unit resynchronizes the journal, the journal synchronization unit resynchronizes the journal in a time-ordered sequence.

7. The apparatus of claim 6, wherein, when the journal synchronization unit resynchronizes the journal, the journal synchronization unit uses an asynchronous resynchronization method, in which a function of receiving and processing a new request for an operation for metadata is enabled during resynchronization, or a synchronous resynchronization method, in which the function of receiving and processing a new request for an operation for metadata is disabled during resynchronization.

8. The apparatus of claim 7, wherein, when the journal synchronization unit resynchronizes the journal, if an amount of inconsistency in the journal is greater than a preset amount, the journal synchronization unit uses the asynchronous resynchronization method, but otherwise, the journal synchronization unit uses the synchronous resynchronization method.

9. The apparatus of claim 8, wherein, when the journal synchronization unit resynchronizes the journal using the asynchronous resynchronization method, the journal synchronization unit recalculates the amount of inconsistency in the journal by reflecting a new request for an operation for metadata, which is received during resynchronization of the journal, selects the asynchronous resynchronization method or the synchronous resynchronization method in consideration of the recalculated amount of inconsistency, and resynchronizes the journal again using the selected method.

10. The apparatus of claim 9, wherein, when the journal synchronization unit resynchronizes the journal using the synchronous resynchronization method, the journal synchronization unit starts a grace period during which a new request for an operation for metadata is blocked, synchronizes the journal when transactions corresponding to requests for operations that were input before the start of the grace period are completed, and finishes the grace period when resynchronization of the journal using the synchronous resynchronization method is completed.

11. A method for controlling synchronization of metadata, comprising:
creating a transaction corresponding to a request for an operation for metadata, the request being received from a client;
storing the transaction in a journal;
comparing the journal in a node with an external journal in an additional node connected therewith and transmitting and receiving only an inconsistency between the journal and the external journal, thereby synchronizing the journal; and
processing the request for the operation or the transaction for the metadata.

12. The method of claim 11, wherein storing the transaction is configured to store the transaction in the journal by appending the transaction thereto and to manage the journal by dividing the journal into units having a preset size.

13. The method of claim 12, wherein processing the request for the operation or the transaction is configured such that, after the transaction corresponding to the request for the operation is stored in the journal, the request for the operation or the transaction is processed and a result thereof is reflected in a table that stores content of the metadata.

14. The method of claim 13, wherein processing the request for the operation or the transaction is configured such that, when the journal is changed through the synchronization, transactions corresponding to the change are processed and a result thereof is reflected in the table.

15. The method of claim 14, wherein synchronizing the journal comprises:
when synchronizing the journal is interrupted because a failure occurs in the additional node, resynchronizing the journal with a new node or with the additional node when the additional node is normalized.

16. The method of claim 15, wherein resynchronizing the journal is configured to resynchronize the journal in a time-ordered sequence.

17. The method of claim 16, wherein resynchronizing the journal is configured to use an asynchronous resynchronization method, in which a function of receiving and processing a new request for an operation for metadata is enabled during resynchronization, or a synchronous resynchronization method, in which the function of receiving and processing a new request for an operation for metadata is disabled during resynchronization.

18. The method of claim 17, wherein resynchronizing the journal is configured such that, if an amount of inconsistency in the journal is greater than a preset amount, the asynchronous resynchronization method is used, but otherwise, the synchronous resynchronization method is used.

19. The method of claim 18, wherein resynchronizing the journal is configured such that, when the journal is resynchronized using the asynchronous resynchronization method, the amount of inconsistency in the journal is recalculated by reflecting a new request for an operation for metadata, received during resynchronization of the journal, the asynchronous resynchronization method or the synchronous resynchronization method is selected in consideration of the recalculated amount of inconsistency, and the journal is resynchronized using the selected method.

20. The method of claim 19, wherein resynchronizing the journal is configured such that, when the journal is resynchronized using the synchronous resynchronization method, a grace period during which a new request for an operation for metadata is blocked is started, the journal is synchronized when transactions corresponding to requests for operations that were input before the start of the grace period are completed, and the grace period is finished when resynchronization of the journal using the synchronous resynchronization method is completed.
